(19) United States
(12) Patent Application Publication
(10) Pub. No.: US 2012/0240684 A1
(43) Pub. Date: Sep. 27, 2012

(54) COLOR CHANGING HVAC GAUGE AND RELATED METHOD

(76) Inventor: Bryan Alfano, Manchester, CT (US)

(21) Appl. No.: 13/070,367

(22) Filed: Mar. 23, 2011

(51) Int. Cl. G01L 7/00; B23P 17/04

(52) U.S. Cl. 73/714; 29/428

(57) ABSTRACT

In a device for taking pressure readings on a HVAC system, a first gauge is connectable in communication with the HVAC system for taking a first pressure reading thereof. A second gauge is connectable in communication with the HVAC system for taking a second pressure reading thereof that is independent of the first pressure reading. A backlight display of each gauge is configured to illuminate the face of each gauge in a respective color that conveys the type of refrigerant in the HVAC system. An integrated circuit is coupled to the gauges to change the colors of the backlight displays.

### FIELD OF THE INVENTION

The present invention relates to gauges, and more particularly, to heating, ventilating and/or air conditioning (“HVAC”) system gauges with coloration indicative of the type of refrigerant in the HVAC system.

### BACKGROUND

In order to install or service an HVAC system, HVAC service personnel must measure the HVAC system refrigerant pressure and from the refrigerant pressure determine the saturated vapor equivalent temperature for the particular refrigerant used in the HVAC system being installed or serviced. In addition, other parameters, such as trend lines for refrigerant pressure, trend lines for saturated vapor equivalent temperature, instantaneous refrigerant pressure bar graph, or super-heat/sub-cool temperatures of the refrigerant, may be useful in installing or servicing an HVAC system. These and other parameters will vary based on the refrigerant being used. Digital and analog pressure gauges have been used in this field. With analog gauges, the technician uses a table to determine the temperature from the measured pressure. Digital gauges typically include an input for the refrigerant, and parameters are calculated based on the selected refrigerant.

A problem exists in that the HVAC/R technicians generally do not have a quick visual indication of the refrigerant they have selected on their digital manifolds. Selecting the wrong refrigerant can lead to problems in servicing and repairing a HVAC system. Moreover, if the wrong refrigerant is selected, any steps taken to repair the HVAC system may lead to costly damages to the HVAC system because the pressures obtained from the manifold will be incorrect. Conventional digital gauges have attempted to address this problem by providing a small alphanumeric indicator on an LCD screen. These alphanumeric indicators are not highly visible and an incorrect selection by the technician may go unnoticed. Moreover, in dark work environments it is difficult to read the alphanumeric indicators and the technician must first find a flashlight or other source of lighting to set the correct refrigerant before repairs begin.

It is an object of the present invention to overcome one or more of the above-described drawbacks and/or disadvantages of the prior art.

### SUMMARY OF THE INVENTION

In order to solve the problems of difficult to read gauges, the present invention comprises a service gauge with a display that quickly and clearly informs a technician which refrigerant has been selected. The present invention thus makes it possible to identify the selected refrigerant and quickly begin repairing HVAC systems.

In accordance with a first aspect, the present invention is directed to a device comprising a first gauge connectable in communication with a HVAC system including a refrigerant for displaying a first pressure reading thereof. At least a portion of the first gauge is colored a respective color indicative of the type of the refrigerant in the HVAC system. A controller is coupled to the first gauge and is configured to change the color of the colored portion of the first gauge to indicate the respective type of refrigerant in the HVAC system.

In some embodiments of the present invention, the device further includes at least one light source that illuminates the colored portion of the first gauge in the color indicative of the respective type of refrigerant. In some such embodiments, the at least one light source is a backlight of the first gauge. In some such embodiments, the first gauge includes an electronic display, and the at least one light source is a backlight of the electronic display. In some such embodiments, the electronic display is configured to display the first pressure reading and the backlight thereof is configured to illuminate the display in the color indicative of the respective type of refrigerant.

In some embodiments of the present invention, the device further comprises a second gauge connectable in communication with the HVAC system including a refrigerant for displaying a second pressure reading thereof. At least a portion of the second gauge is colored a respective color indicative of the type of the refrigerant in the HVAC system. The controller is coupled to the second gauge and is configured to change the color of the colored portion of the second gauge to indicate the respective type of refrigerant in the HVAC system.

In some embodiments of the present invention, the at least one light source is a multi-color LED light source, such as RGB (Red, Green and Blue) LEDs, and the controller changes the color thereof to correspond to the color indicative of the respective refrigerant by pulse width modulating the multi-color LED light source.

In some embodiments of the present invention, the controller is responsive to a user's selection of the type of refrigerant in the HVAC system to change the color of the colored portion of the first gauge to a color corresponding to the selected refrigerant type. In some such embodiments, the controller is configured to display the colored portion in the color that corresponds to the EPA color of the selected type of refrigerant. The device preferably comprises at least one input to the controller for selecting the refrigerant used in the HVAC system and in turn coloring the colored portion in the color that corresponds to the selected refrigerant.

In accordance with another aspect, the present invention is directed to a device comprising first means connectable in communication with a HVAC system including a refrigerant for displaying a first pressure reading thereof; and second means for coloring at least a portion of the first means a respective color indicative of the type of the refrigerant in the HVAC system. Third means is coupled to the second means for changing the color of the second means to indicate the respective type of refrigerant in the HVAC system.

Some embodiments of the present invention further comprise fourth means connectable in communication with the HVAC system including a refrigerant for displaying a second pressure reading thereof; and fifth means for coloring at least a portion of the fourth means a respective color indicative of the type of the refrigerant in the HVAC system. The third means is coupled to the fifth means for changing the color of the fifth means to indicate the respective type of refrigerant in the HVAC system.

In some embodiments of the present invention, the first means is a first gauge, the second means is a light source of the first gauge, the third means is a controller or integrated circuit, the fourth means is a second gauge and the fifth means is a light source of the second gauge.

In accordance with another aspect, the present invention is directed to a method comprising the following steps:

connecting a first gauge in communication with a first HVAC system including a first refrigerant for displaying a pressure reading thereof; and

coloring a colored portion of the first gauge a color that corresponds to the first refrigerant in the first HVAC system.

In some embodiments of the present invention, the coloring step includes inputting into a controller connected to the first gauge the type of refrigerant in the first HVAC system and in turn changing the color of the colored portion of the first gauge to indicate the respective type of refrigerant in the first HVAC system. In some embodiments, the coloring step includes illuminating at least one light source of the first gauge in the color that corresponds to the respective refrigerant in the first HVAC system. Preferably, the coloring step includes illuminating at least one light source of the first gauge in a color that corresponds to the EPA color of the respective refrigerant.

Some embodiments of the present invention further comprise the steps of (i) connecting the first gauge in communication with a second HVAC system different than the first HVAC system, and including a second refrigerant for displaying a pressure reading thereof, and (ii) coloring the colored portion of the first gauge a second color that corresponds to the second refrigerant in the second HVAC system that is different than the first color corresponding to the first refrigerant.

One advantage of the present invention is that the gauge indicates the type of refrigerant used through the colored portion of the gauge, such as the backlight color of the gauge face or display. Yet another advantage of the present invention is that the colored portion of the gauge, such as the backlight color of the gauge face or display, can be changed based on the type of refrigerant used. A further advantage of the present invention is that the colored portion of the gauge is easily viewed, and understood to indicate a respective refrigerant type, in any of numerous different lighting conditions, and thus overcomes the drawbacks of the above-described prior art devices wherein refrigerant type readouts cannot be easily viewed, particularly in poor lighting conditions.

Other objects and advantages of the present invention, and/or of the currently preferred embodiments thereof, will become more readily apparent in view of the following detailed description of currently preferred embodiments and accompanying drawings.

### BRIEF DESCRIPTION OF THE DRAWINGS

FIG. 1 is a schematic front view of one embodiment of a gauge set of the present invention showing the selection of a first refrigerant and the corresponding backlight color of the gauge displays; and

FIG. 2 is a schematic front view of one embodiment of a gauge set of the present invention showing the selection of a second refrigerant and the corresponding backlight color of the gauge displays.

### DETAILED DESCRIPTION OF CURRENTLY PREFERRED EMBODIMENTS

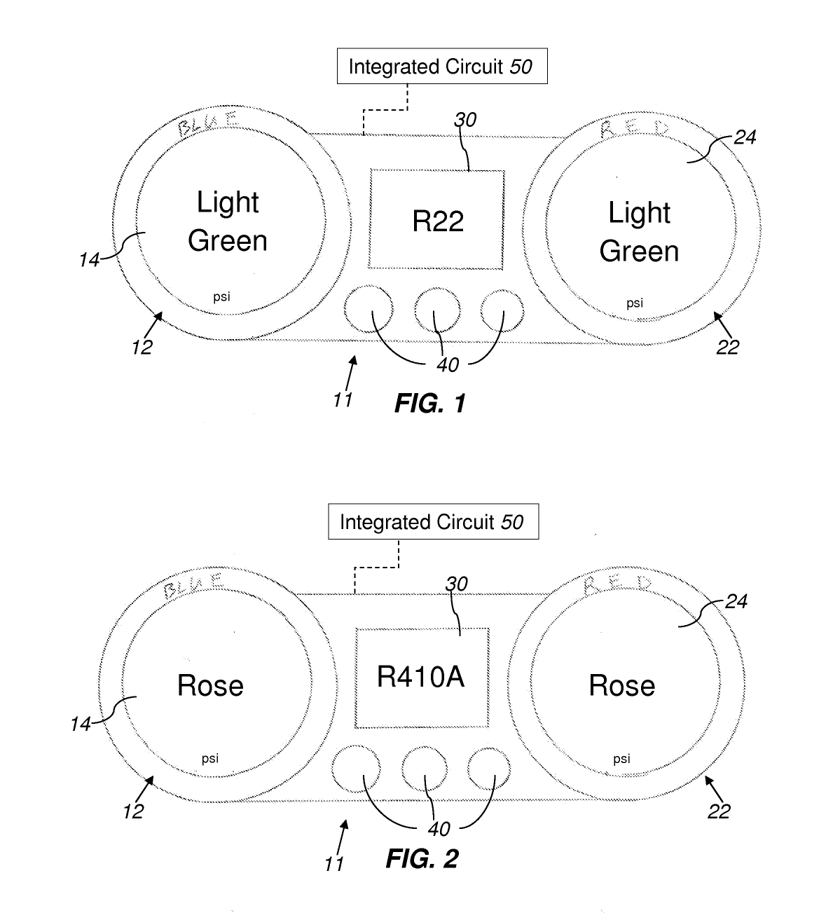

Referring to the drawings and, in particular, FIGS. 1 and 2, a gauge set 11 monitors the physical characteristics of a HVAC system, such as fluid pressures. The gauge set 11 includes a first low pressure gauge 12 and a second high pressure gauge 22. Traditionally, and as indicated in FIGS. 1 and 2, the low pressure gauge 12 is identified with the color blue while the high pressure gauge 22 is identified with the color red. When a technician connects the HVAC gauge 11 to a HVAC system, she or he connects the low pressure side of the HVAC system to the low pressure gauge 12, and the high pressure gauge hose to the high pressure gauge 22. The HVAC gauge set 11 allows a technician to check an HVAC unit's operating pressures, transfer refrigerant, pressure test the system, purge the system with nitrogen, and perform other necessary or regular maintenance tasks.

The low pressure gauge 12 is typically mounted on the left side of the air conditioning gauges. The low pressure gauge allows an HVAC technician to measure both the pressure above atmospheric pressure and vacuum pressure (below atmospheric pressure). The high pressure gauge 22 is typically mounted on the right side of the manifold set and measures pressure above the atmosphere pressure.

As seen in FIG. 1, the two gauges 12, 22 include backlight displays 14 and 24, respectively, for backlighting the gauges. In at least some embodiments, the backlight displays 14, 24 are LED backlights. The backlight displays 14, 24 are capable of conveying information to the technician quickly and clearly. In the currently preferred embodiments, the backlight displays 14, 24 are capable of changing colors. Although the blue and red external coloring of the gauges 12 and 22, respectively, could be changeable, if desired, in the illustrated embodiment they are not changeable. Colored backlight displays 14, 24 are particularly useful when a technician is working in a dark or poorly lit environment. The backlight displays 14, 24 are also useful because, based on the backlight color of each display, a technician is able to ascertain the selected refrigerant or refrigerant in use from far away, and thus the gauges avoid the problems associated with conventional gauges requiring technicians to read small alphanumeric printing or type to determine the refrigerant in use.

An integrated circuit or controller 50 is coupled to the backlight displays 14, 24 to change the colors of the displays based on the selected refrigerant in use. The integrated circuit 50 may be programmed with a variety of settings relating to various refrigerants. The integrated circuit 50 is further coupled to a LCD screen or display as will be discussed below to convey information or other messages. In the illustrated embodiment, the light source forming the backlight of each gauge display 14, 24 is a multi-color LED light source, such as RGB (Red, Green and Blue) LEDs. RGB LED light sources are capable of achieving different colors by mixing different amounts of the three primary colors (red, green, blue). Most perceivable colors can be formed with such light sources. The mixing of the primary colors to effect the desired refrigerant color can be achieved by pulse-width modulating the RGB LED light source. The integrated circuit 50 is programmed with a variety of presets, one for each refrigerant type, to pulse-width modulate the RGB LED sources to achieve predetermined colors corresponding to respective presets or refrigerant types.

The colors of the backlight displays 14, 24 may be selected to match the EPA colors of respective refrigerants. By utilizing the EPA color scheme, the currently preferred embodiments of the present invention provide a device and method by which the selected refrigerant is quickly recognized by the technician as technicians are generally familiar with the EPA refrigerant color scheme. The illuminated colors of the backlight displays 14, 24 further provide enough light for the technician to easily read the measured pressured on the gauges. Table A, below, provides a sample of common refrigerants, their chemical names and the color code that corresponds to each refrigerant. The refrigerant color codes of Table A are provided in “Refrigeration & air conditioning technology,” Whitman, William C., Johnson, William M. and Tomczyk, John A. 5th Edition, Illustrated. Publisher Cengage Learning, (2004), which is hereby expressly incorporated by reference in its entirety as part of the present disclosure.

| Refrigerant | Chemical Name | Color Code |
|---|---|---|
| R11 | Trichlorfluoromethane | Orange |
| R12 | Dichlorodifluoromethane | White |
| R13 | Chlorotrifluoromethane | Light Blue |
| R113 | Trichlorotrifluoroethane | Dark Purple |
| R114 | Dichlorotetrafluoroethane | Navy Blue |
| R12/114 | Dichlorodifluoromethane, | Light Gray |
| | Dichlorotetrafluoroethane | |
| R13B1 | Bromotrifluoromethane | Pinkish-Red |
| R-22 | Chlorodifluoromethane | Light Green |
| R-23 | Trifluoromethane | Light Blue Gray |
| R123 | Dichlorotrifluoroethane | Light Blue Gray |
| R124 | Chlorotetrafluoroethane | DOT Green |
| R134a | Tetrafluoroethane | Light Blue |
| R401A | Chlorodifluoromethane, | Pinkish-Red |
| | Difluoroethane, | |
| | Chlorotetrafluoroethane | |
| R401B | Chlorodifluoromethane, | Yellow-Brown |
| | Difluoroethane, | |
| | Chlorotetrafluoroethane | |
| R402A | Chlorodifluoromethane, | Light-Brown |
| | Pentafluoroethane, | |
| | Propane | |
| R402B | Chlorodifluoromethane, | Green-Brown |
| | Pentafluoroethane, | |
| | Propane | |
| R403B | Chlorodifluoromethane, | Light Gray |
| | Octafluoropropane, | |
| | Propane | |
| R404A | Pentafluoroethane, | Orange |
| | Trifluoroethane, | |
| | Tetrafluoroethane | |
| R407C | Difluoromethane, | Brown |
| | Pentafluoroethane, | |
| | Tetrafluoroethane | |
| R408A | Chlorodifluoromethane, | Medium Purple |
| | Trifluoroethane, | |
| | Pentafluoroethane | |
| R409A | Chlorodifluoromethane, | Medium Brown |
| | Chlorotetrafluoroethane, | |
| | Chlorodifluoroethane | |
| R410A | Difluoromethane, | Rose |
| | Pentafluoroethane | |
| R414B | Chlorodifluoromethane, | Medium Blue |
| | Chlorotetrafluoroethane, | |
| | Chlorodifluoroethane, | |
| | Isobutane | |
| R416A | Tetrafluorethane, | Yellow-Green |
| | Chlorotetrafluoroethane, | |
| | Butane | |
| R417A | Pentafluoroethane, | Green |
| | Tetrafluoroethane, | |
| | Isobutane | |
| R500 | Dichlorotrifluoromethane, | Yellow |
| | Difluoroethane | |
| R502 | Chlorodifluoromethane, | Light Purple |
| | Chloropentafluoroethane | |
| R503 | Chlorotrifluoromethane, | Blue-Green |
| | Trifluoromethane | |
| R507 | Pentafluoroethane, | Aqua Blue |
| | Trifluoroethane | |
| R508B | Trifluoromethane, | Dark Blue |
| | Hexafluoroethane | |

As can be appreciated from Table A, by displaying a color, the selected refrigerant can be easily identified. Moreover, those skilled in the art are familiar with the refrigerant color scheme and thus the present invention provides an intuitive mechanism to quickly ascertain whether the proper refrigerant has been selected. For example, the backlights may illuminate the displays 14, 24 with the color “green” when the refrigerant selected is R22, as shown typically in FIG. 1. Similarly, the backlights may illuminate the displays 14, 24 with the color “rose” when the refrigerant selected is R410A, as shown typically in FIG. 2.

An optional display screen 30, such as a LCD screen, may be disposed between the two gauges 12, 22. The display screen 30 displays various information such as the type of refrigerant being used, and the pressure and/or temperatures, such as super heated and sub-cooling refrigerant temperatures. The display screen 30 may further display messages informing a technician of conditions relating to calibration or other settings. Below the display screen 30, a variety of buttons, knobs or switches 40 may be disposed, which aid the user in selecting different parameters. In at least some embodiments, one of the buttons 40 is used to select or cycle through various refrigerants. As the technician selects a refrigerant, the backlight displays 14, 24 change color to correspond to the selected refrigerants. The buttons 40 may further toggle a switch between units such as temperature from degrees Fahrenheit to degrees Celsius or units of pressure such as psi or bar. In at least some embodiments, at least one of the buttons 40 initiates a calibration or resets the device so that it is calibrated.

As may be recognized by those of ordinary skill in the pertinent art based on the teachings herein, numerous changes and modifications may be made to the above-described and other embodiments of the present invention without departing from the scope of the invention as defined in the appended claims. Many of the features or the steps described above are only exemplary, and may be changed as desired, or otherwise as required to meet the requirements of a particular application. For example, in some embodiments, only a single backlight display is used, or a common backlight is provided for multiple displays or gauges. In embodiments that include a plurality of backlight displays, the backlight displays may be programmed to display the same color on all gauges to prevent the device from indicating more than one refrigerant type in a respective HVAC system or unit. Multiple integrated circuits also may also be used, one for each gauge, or one for each of a plurality of gauges. In some embodiments, the integrated circuit or controller may define a pre-selected color, not corresponding to any of the refrigerant colors, that will be displayed when the system encounters an error in calibration or otherwise. In addition, the colors used to identify the different refrigerant types may change from the colors described above and/or new colors may be added to identify new refrigerants. Further, the refrigerant color may be conveyed by any of numerous mechanisms that are currently known, or that later become known, for showing the color of the refrigerant in use, and changing the color to indicate the respective refrigerant selected or in use. For example, the entire gauge face or display need not be illuminated with the respective color; rather only a portion of the gauge face or display may be illuminated with the respective color, such as the periphery or the center, or some portion between the periphery and the center, of the gauge face or display. In addition, the color may be provided by a light or other display formed contiguous to the respective gauge face or display. In other embodiments, the indicia, graduations or other features of the displays may be illuminated in the color of the respective refrigerant selected or in use. Accordingly, this detailed description of the currently preferred embodiments is to be taken in an illustrative, as opposed to a limiting sense.

What is claimed is:

1. A device comprising:
a first gauge connectable in communication with a HVAC system including a refrigerant for displaying a first pressure reading thereof, wherein at least a portion of the first gauge is colored a respective color indicative of the type of the refrigerant in the HVAC system; and
a controller coupled to the first gauge and configured to change the color of the colored portion of the first gauge to indicate the respective type of refrigerant in the HVAC system.

2. A device as defined in claim 1, further including at least one light source that illuminates the colored portion of the first gauge in the color indicative of the respective type of refrigerant.

3. A device as defined in claim 2, wherein the at least one light source is a backlight of the first gauge.

4. A device as defined in claim 2, wherein the first gauge includes an electronic display, and the at least one light source is a backlight of the electronic display.

5. A device as defined in claim 4, wherein the electronic display is configured to display the first pressure reading and the backlight thereof is configured to illuminate the display in the color indicative of the respective type of refrigerant.

6. A device as defined in claim 1, further comprising:
a second gauge connectable in communication with the HVAC system including a refrigerant for displaying a second pressure reading thereof, wherein at least a portion of the second gauge is colored a respective color indicative of the type of the refrigerant in the HVAC system; and
wherein the controller is coupled to the second gauge and is configured to change the color of the colored portion of the second gauge to indicate the respective type of refrigerant in the HVAC system.

7. A device as defined in claim 6, further comprising a screen display configured to show an alphanumeric representation of the type of refrigerant and corresponding to the color of the colored portions of the gauges.

8. A device as defined in claim 3, wherein the at least one light source is a multi-color LED light source, and the controller is configured to change the color thereof to correspond to the color indicative of the respective refrigerant by pulse width modulating the light source.

9. A device as defined in claim 1, wherein the controller is responsive to a user's selection of the type of refrigerant in the HVAC system to change the color of the colored portion of the first gauge to a color corresponding to the selected refrigerant type.

10. A device as defined in claim 9, wherein the controller is configured to display the colored portion in the color that correspond to the EPA color of the selected type of refrigerant.

11. A device as defined in claim 1, further comprising at least one input for selecting the refrigerant used in the HVAC system and in turn coloring the colored portion in the color that corresponds to the selected refrigerant.

12. A device comprising:
first means connectable in communication with a HVAC system including a refrigerant for displaying a first pressure reading thereof;
second means for coloring at least a portion of the first means a respective color indicative of the type of the refrigerant in the HVAC system; and
third means coupled to the second means for changing the color of the second means to indicate the respective type of refrigerant in the HVAC system.

13. A device as defined in claim 12, wherein the first means is a first gauge, the second means is a light source of the first gauge, and the third means is a controller.

14. A device as defined in claim 12, further comprising:
fourth means connectable in communication with the HVAC system including a refrigerant for displaying a second pressure reading thereof;
fifth means for coloring at least a portion of the fourth means a respective color indicative of the type of the refrigerant in the HVAC system;
wherein the third means is coupled to the fifth means for changing the color of the fifth means to indicate the respective type of refrigerant in the HVAC system.

15. A device as defined in claim 14, wherein the fourth means is a second gauge, the fifth means is a light source of the second gauge, and the third means is a controller.

16. A method comprising the following steps:
connecting a first gauge in communication with a first HVAC system including a first refrigerant for displaying a pressure reading thereof; and
coloring a colored portion of the first gauge a color that corresponds to the first refrigerant in the first HVAC system.

17. A method as defined in claim 16, wherein the coloring step includes inputting into a controller connected to the first gauge the type of refrigerant in the first HVAC system and in turn changing the color of the colored portion of the first gauge to indicate the respective type of refrigerant in the first HVAC system.

18. A method as defined in claim 17, wherein the coloring step includes illuminating at least one light source of the first gauge in the color that corresponds to the respective refrigerant in the first HVAC system.

19. A method as defined in claim 18, further comprising the steps of connecting the first gauge in communication with a second HVAC system different than the first HVAC system and including a second refrigerant for displaying a pressure reading thereof, and coloring the colored portion of the first gauge a second color that corresponds to the second refrigerant in the second HVAC system that is different than the first color corresponding to the first refrigerant.

20. A method as defined in claim 16, wherein the coloring step includes illuminating at least one light source of the first gauge in a color that corresponds to the EPA color of the respective refrigerant.

21. A method as defined in claim 16, further comprising the steps of
connecting a second gauge in communication with the first HVAC system including a first refrigerant for displaying a pressure reading thereof; and
coloring a colored portion of the second gauge a color that corresponds to the first refrigerant in the first HVAC system.
